(19) United States
(12) Patent Application Publication
(10) Pub. No.: US 2016/0150897 A1
(43) Pub. Date: Jun. 2, 2016

(54) Shot Glass Assembly

(71) Applicants: Richard Zwarych, Calgary (CA); Patrick Zwarych, Calgary (CA)

(72) Inventors: Richard Zwarych, Calgary (CA); Patrick Zwarych, Calgary (CA)

(21) Appl. No.: 14/955,809

(22) Filed: Dec. 1, 2015

Related U.S. Application Data
(60) Provisional application No. 62/086,184, filed on Dec. 1, 2014.

(30) Foreign Application Priority Data
Dec. 1, 2014 (CA) 2872842

(51) Int. Cl. A47G 19/22; G01G 19/52; G01G 17/04

(52) U.S. Cl. CPC A47G 19/2227; G01G 17/04; G01G 19/52; A47G 2200/226

(57) ABSTRACT

In one aspect the invention provides a shot glass assembly comprising a cup suitable to hold a quantity of liquid, at least one load sensor, a microcomputer and a power source. The load sensor is operative to sense the weight of the cup and any liquid therein and provides a first signal. The microcomputer may process the first signal to provide a first output that is indicative of an amount of liquid held in the cup. The shot glass assembly may further comprise an accelerometer to provide a second signal that is indicative of any motion that may be experienced by the cup. The microcomputer may be programmed to process the first signal, and any second signal, to generate a second output that is indicative of a total volume of liquid held with the cup over a period of time.

### CROSS REFERENCE TO RELATED APPLICATION

This application is a regular application of U.S. Provisional Patent Application Ser. No. 62/086,184 filed Dec. 1, 2014 and entitled, “SHOT GLASS ASSEMBLY”, the entirety of which is incorporated herein by reference.

### FIELD OF THE INVENTION

This invention relates generally to shot glasses and to measuring quantities of liquid. More particularly, the invention relates to a shot glass assembly having means to calculate the amount of liquor consumed over time via the shot glass assembly.

### BACKGROUND OF THE INVENTION

The background information discussed below is presented to better illustrate the novelty and usefulness of the present invention. This background information is not admitted prior art.

A shot glass is a small glass designed to hold or measure spirits or liquor, which is then either drunk straight from the glass (“a shot”) or poured into a cocktail. The origin of the term “shot” is unclear. A popular origin story is that the shot glass originated in the Western saloons of the American Old West. This story explains that the cowboys of the Old West would trade a cartridge (or shot) for a small amount of alcohol. There are, however, more complex stories about the origin of the style of glass and its name. Because the word shot also means “dose” or “small amount”, it may simply be that these small glasses are called shot glasses because they hold small, powerful amounts of spirits or liquor.

With respect to the practical aspect of measuring a specific an amount of spirits or liquor, most countries have standard definitions of “single”- and “double”-shot sizes (which are not always in a one-to-two ratio). For example, in Canada, a “shot” generally refers to the province's definition of a “standard drink” under liquor licenses. Although sizes may vary, most provinces cite amounts similar to Ontario's guidelines of 0.6 fl. oz. (or 17 mL) of pure alcohol. Since a “shot” is typically not pure alcohol but a spirit with only about 40 percent alcohol, this makes the volume of the “shot” 1.5 fl. oz. (or 42.62 mL); although many establishments serve a lower “standard drink” of only 1 fl. oz. A double shot in North America may be either 2.5 or 3.0 fluid ounces. A smaller 1.0 fl. oz. shot is usually referred to as a “pony shot” or “short shot”.

Shot glasses are featured prominently in drinking games, either as a game component, prop or tool (e.g. in the game of quarters where the player attempts to bounce a coin off a table to land into a shot glass) or as a utensil to measure the volume of alcoholic beverage consumed by the game participants (e.g. in an endurance game in which players compete to out-drink one another, take turns taking shots, with the last person standing being the winner). Shot glasses are also used by drinkers to keep track of how much alcohol was consumed, with the number of “shots” counted on a drinker's arm, a piece of paper or smart phone. Often the goal of the players it to reach the highest number of shots consumed.

However, after a night of playing drinking games, or even after just sitting around the bottle with a few friends, many individuals have difficulties keeping an accurate track of how much alcohol they consumed. This is because of a number of reasons, including that individuals who consume alcohol have difficulties keeping accurate count of the number of “shots” consumed during an evening and because, as an individual become more intoxicated, they often only partially fill their shot glass, but still count it as a full shot.

Therefore, what is needed is a measuring device or apparatus that keeps accurate track of a user's alcoholic consumption.

### BRIEF DESCRIPTION OF THE DRAWINGS

Referring to the drawings, several aspects of the present invention are illustrated by way of example, and not by way of limitation, in detail in the figures, wherein:

FIG. 1 is a front schematic view of a first embodiment of a shot glass assembly;

FIG. 2a is a schematic front perspective view of another embodiment of a shot glass assembly;

FIG. 2b is a schematic front perspective view of the embodiment of the shot glass assembly of FIG. 2a, with the base being translucent and showing the load sensor therein;

FIGS. 2c-2d are schematic top and bottom perspective views of the embodiment of the shot glass assembly of FIG. 2a, with the base being translucent;

FIG. 2e is a schematic perspective view of the cup and the load sensor components of the embodiment of the shot glass assembly of FIG. 2a;

FIG. 2f is a schematic perspective view of the base and the load sensor components of the embodiment of the shot glass assembly of FIG. 2a;

FIGS. 3a-3c are various perspective views of yet another embodiment of a shot glass assembly;

FIG. 4 is a perspective view of additional embodiments of a shot glass assembly; and

FIGS. 5a-5d are various perspective views of a further embodiment of a shot glass assembly, with the cup being disassembled from the base, revealing a number of the interior components of this embodiment.

### DETAILED DESCRIPTION OF THE PREFERRED EMBODIMENTS

The following description is of preferred embodiments by way of example only and without limitation to the combination of features necessary for carrying the invention into effect. Reference is to be had to the Figures in which identical reference numbers identify similar components. The drawing figures are not necessarily to scale and certain features are shown in schematic or diagrammatic form in the interest of clarity and conciseness.

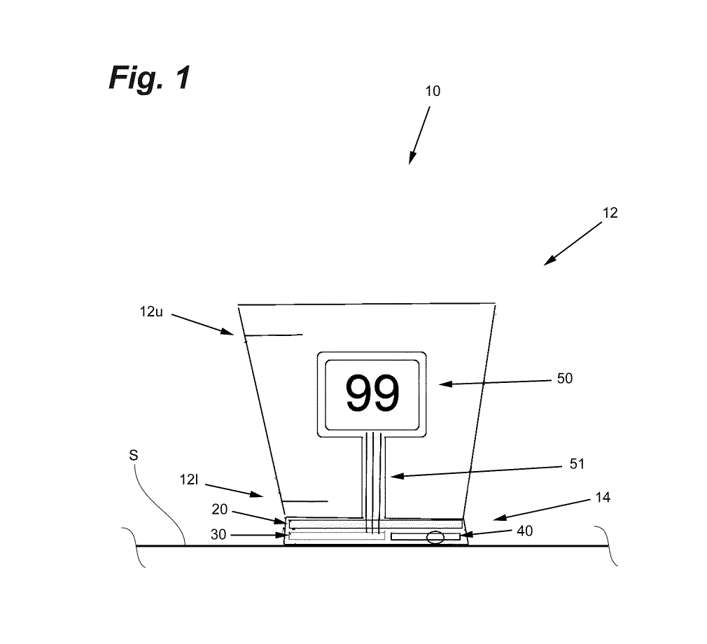

Various embodiments of the shot glass assembly 10 of the present invention are shown in FIGS. 1-5d. In these embodiments, the shot glass assembly 10 comprises a cup 12 suitable to hold a quantity of liquid L, a base 14, at least one load sensor 20, a microcomputer 30 and a power source 40. The load sensor 20 is preferably housed in the base 14 and the power source 40 may be one or more button cell lithium batteries 40b (e.g. two CR2032 batteries).

The cup 12 may be provided in a variety of shapes, colours and degrees of transparency. The base 14 may likewise be provided in a variety of shapes colours or levels of transparency (e.g. see FIG. 4 which illustrates two bases 14 in a lighter colour and a third base 14 in a dark colour). Alternatively, and to simplify manufacturing, the base 14 may be provided in as a single design option (e.g. opaque, black colour), with different looks and variety in design of the shot glass assembly 10 being provided by different styles and shapes of cups 12. Preferably, the cup 12 is sized to hold at least one fluid ounce (1 fl. oz.) of liquid. More preferably, the cup 12 is sized to hold 1.5 fluid ounces (1.5 fl. oz.) of liquid and has one or more measuring lines, such as an upper measuring line 12u to mark the 1.2 fl. oz. level and a lower measuring line 12l to mark the 0.1 fl. oz. level (see FIG. 1).

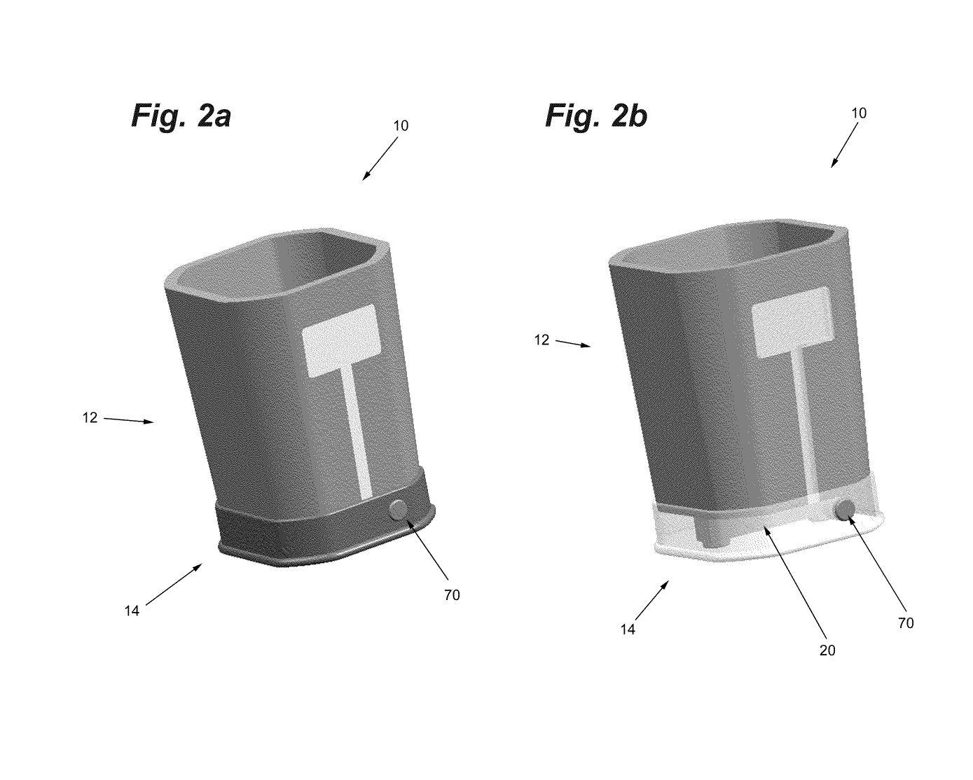

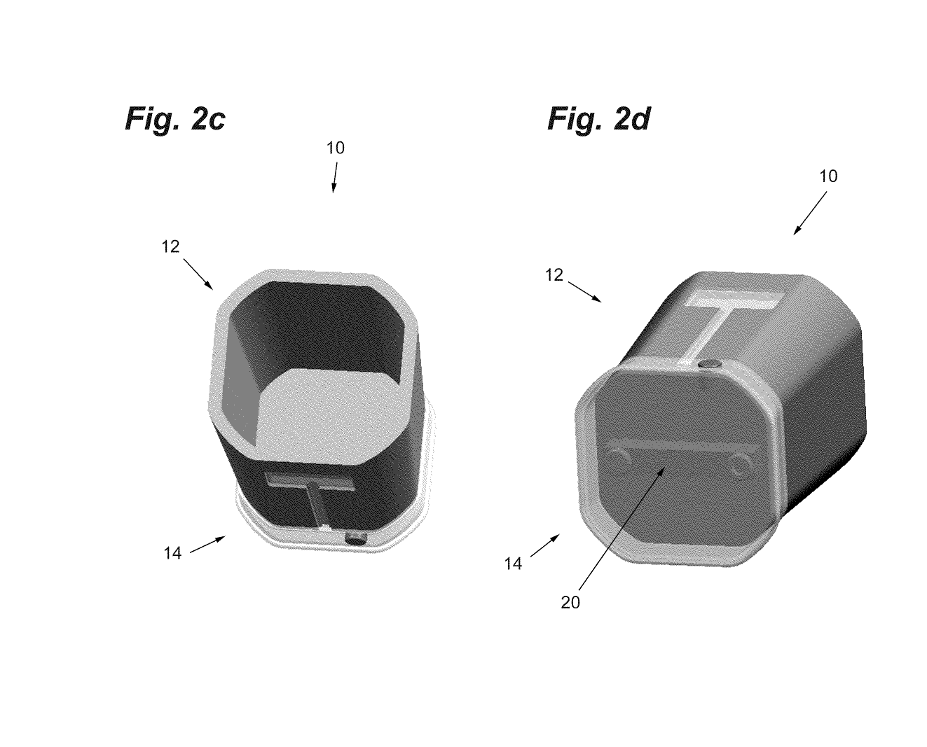

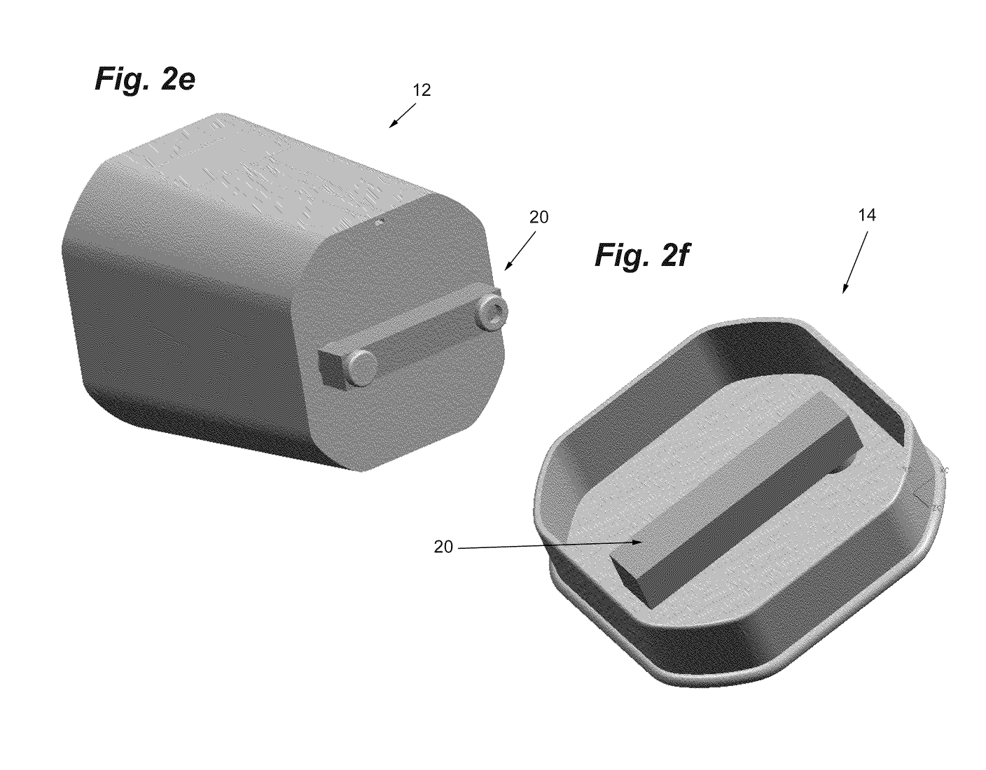

In these embodiments, the load sensor 20 is disposed inside the base 14 so as to at least partially, if not fully, support the cup 12 when the assembly 10 is placed in the normal upright position on a generally horizontal surface S such as a table top (e.g. as shown in FIG. 2a, with the cup 12 being supported on the base 12 via load sensor 20 and with the base 14 being supported by the generally horizontal surface S). Advantageously, the weight of the cup 12 and any liquid L inside will therefore be sensed by the load sensor 20. The microcomputer 30 and power source 40 are also preferably disposed within the base 14. In other embodiments (not shown), the shot glass assembly 10 may feature a only a cup 12, with the load sensor 20 being housed inside said cup 20 and supporting the cup 12 on a generally horizontal surface S such as a table top (in such an embodiment, the weight of the cup 12 and any liquid L inside will also be sensed by the load sensor 20).

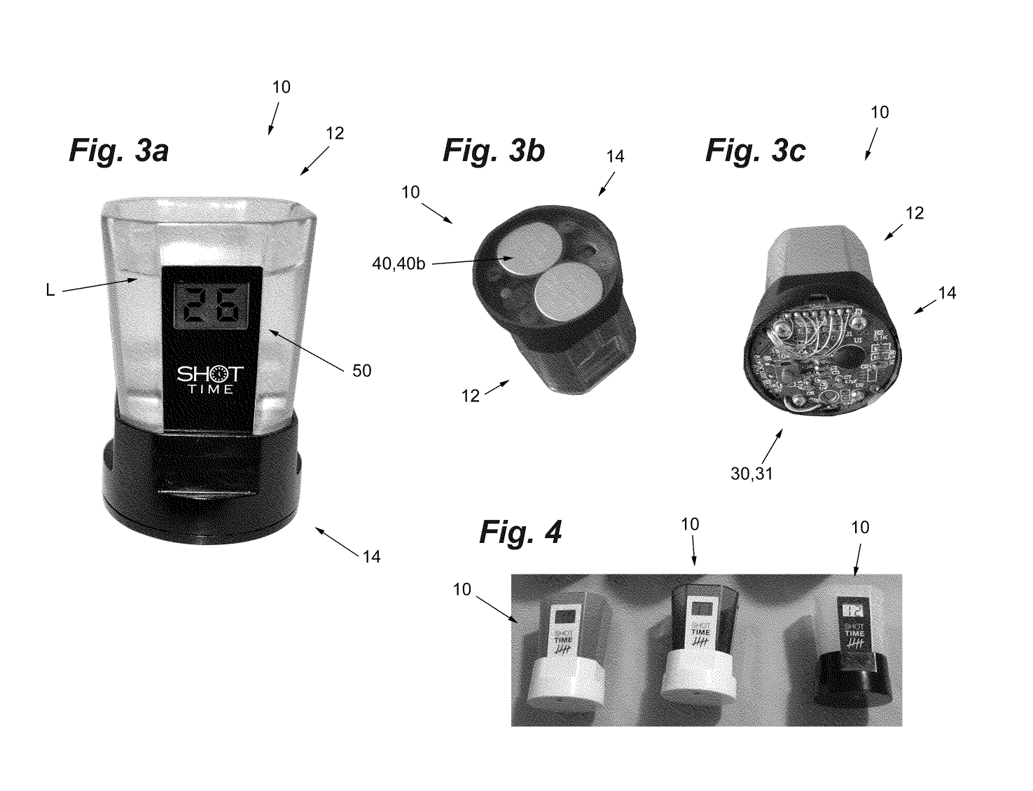

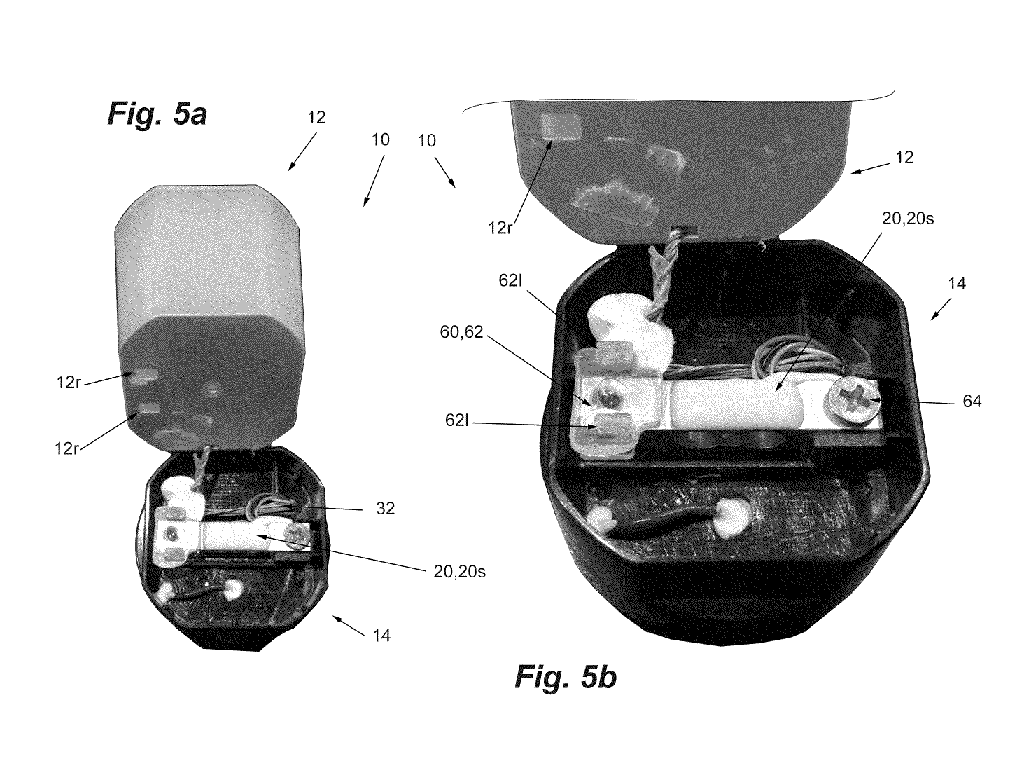

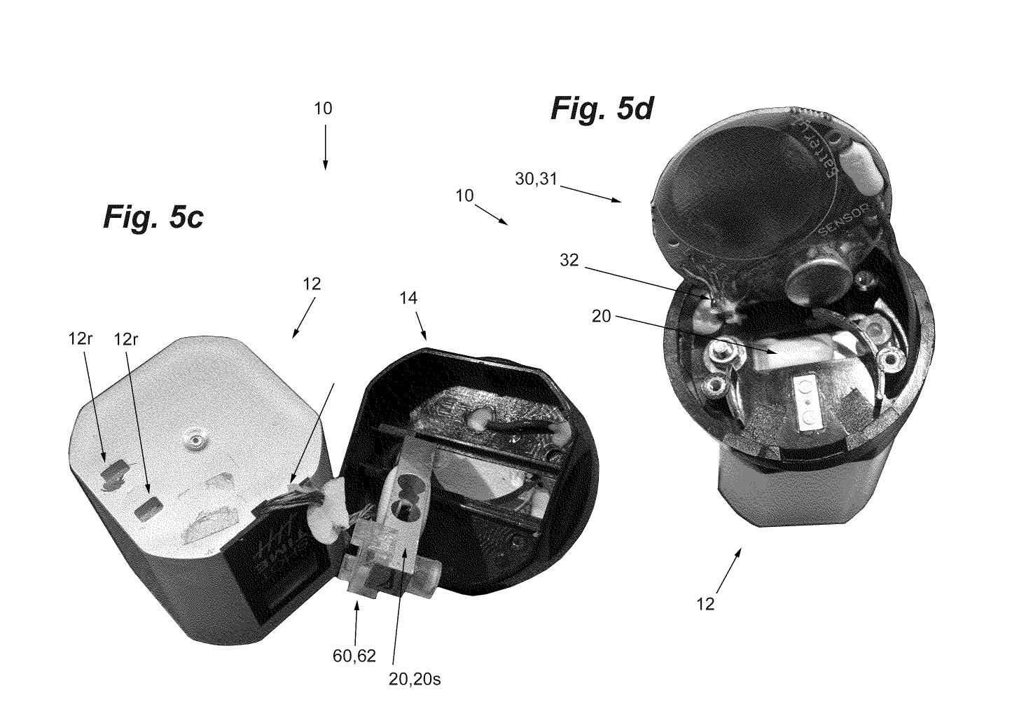

Preferably in the embodiments where a base 14 is present, cup retaining means 60 are provided to maintain the cup 12 in an engagement position with the base 14 during normal operations (e.g. with cup 12 and base 14 as shown in FIGS. 2a and 3a), and with the base 14 being substantially below the cup 12 and with the weight of the cup 12 (and any contents therein) being at least partially, if not fully, supported by the load sensor 20. Cup retaining means 60 may comprise a clip member 62 on that side of the load sensor 20 facing the cup and a screw or bolt 64 to fasten the load sensor to the base 14. Clip member 62 preferably features one or more legs 62l suitably sized to grip corresponding recesses 12r provided in the base of the cup 12 (see FIGS. 5a and 5b) and thereby maintain engagement of the cup 12 with the load sensor 20 via friction fit. Alternatively in another embodiment, not shown, cup 12 may be maintained in an engagement position with the base by gluing one side of the load sensor 20 to the base 14 and gluing the opposing side of the load sensor 20 to the cup 12. Alternatively in yet another embodiment, also not shown, cup 12 may be maintained in an engagement position with the base 14 by a first screw fastening one side of the load sensor 20 to the base 14 and a second screw fastening the opposing side of the load sensor 20 to the cup 12. Other conventional fastening means (including Velcro™) may be utilized to maintain cup 12 in an engagement position with the base 14.

The load sensor 20 may be a digital electronic scale weighing sensor, load cell, or similar type of load transducer having strain gauges or other means to convert any weight or load acting on it into electrical signals. The use of load cells and load transducers to obtain an electrical signal indicative of the weight (or load) placed on the load sensor is well known. Typically, a load cell is composed of an aluminum alloy spring element 20s, four strain gauges and a Wheatstone bridge circuit. This arrangement allows for the creation of an electrical signal whose magnitude is directly proportional to the force (or weight) being measured by the load sensor 20. Strain gauge load cells are the most common type of load cell in industry. Preferably, the load sensor 20 is suitable to detect changes of weight to within 0.1 oz. More preferably the load sensor 20 comprises a 0-300 gram load cell or a 0-1000 gram load cell.

Preferably the microcomputer 30 is mounted on a microcomputer board 31 provided in the interior of the base 14. As is conventional, the microcomputer 30 and board 31 are preferably electrically connected to the load sensor 20, preferably via suitable electrical wiring 32 (e.g. see FIGS. 5a and 5d), to receive electrical signals from said sensor 20. As is also conventional, the microcomputer 30 and/or the board 31 preferably include a ROM, RAM, appropriate analog-to-digital (AD) converter, amplifiers and the like, all of which are not shown. Microcomputer 30 preferably controls the operation of the shot glass assembly 10 in accordance with a program stored in the ROM and/or RAM. Further the RAM is, for example, a non-volatile memory such as a flash memory. Any amplifies and any analog-to-digital converters convert the electrical signals from the load sensor 20 into digital format (i.e. input) for the microcomputer 30 to process.

During operations, and as is known to those skilled-in-the art of strain gauge load cells, load sensors 20 and microcomputers 30, electrical power from the power source 40 is supplied to the load sensor 20, the computer 30 and board 31, causing the load sensor 20 to output a signal to the computer 30 (via wiring 32) that is indicative of the load on the load sensor 20. Because the cup 12 is preferably fully supported by the load sensor 20, such load sensor 20 signal to the computer 30 then also indicative of the load of the cup 12 and any contents therein. As liquid L content is poured into the cup 12, and the load on the load sensor 20 increases, the signals from the load sensor 20 will change accordingly. Similarly, as liquid content is removed from the cup 12, and the load on the load sensor 20 decreases, the signals from the load sensor 20 will change appropriately.

Preferably an output device in the form of a video display 50 is provided to show and display desired output from the microcomputer 30 to a user and to provide an indication of liquid measurement made by the assembly 10. The display 50 is preferably a flat panel display, such as a seven-segment display capable of displaying two digits of arabic numerals. A suitable display 50 is a two-digit liquid-crystal display (LCD). Other types of output devices may also work with the invention 10, including touchscreen displays (not shown, but which can be used to provide additional input to the microcomputer 30), or an audio output signal via a speaker, or a wireless output signal to a user's smartphone. Output may even be stored on a removable non-volatile memory card, such as an SD card; for subsequent retrieval by a user.

The display 50 may be mounted on the exterior of the cup 12 (as shown in the Figures) and operably connected to the microcomputer 30 via wiring 51. Or the display 50 may be provided on the base 14 (not show). Advantageously, if the display is provided on the base 14, and the cup 12 is removable retained in the engagement position by cup retaining means 60, cup 12 may be removable from base 14 (and all electronic components of the assembly 10 contained therein), thereby allowing cup 12 to be washed in a dishwasher without fear of harming the electronic components of the assembly 10.

Preferably an on/off switch 70 is provided to turn the assembly 10 (and load sensor 20, microcomputer 30, board 31, display 50 and any other electronics) on or off as may be desired by a user. On/off switch 70 can therefore also function as an input to the microcomputer 30 to initiate one or more programs in ROM or RAM upon being turned on. The programming of a microcomputer 30 to accept sensory input from a load sensor 20, to calibrate a load sensor 20 and to display output, such as via a display 50, is known to those skilled in the art. The present invention is not directed to new methods of such microcomputer programming, but rather to the novel application of using a load sensor 20 within a shot glass assembly 10 to provide desired and useful output to a user thereof, including output that is indicative of the total amount of liquid L (such as spirits or liquor) that might have been held within the cup 12 over a period of time. To the knowledge of the inventor, using a load sensor 20, a microcomputer 30 and an output device such as a display 50 as part of a shot glass assembly 10 is novel.

Preferably a motion sensor, such as a multi-axis micromachined accelerometer (not shown), is also provided within the assembly 10; preferably within the base 14 and on the board 31. The motion sensor preferably provides input signals to the microcomputer 30 indicative of any motion or acceleration that may be experienced by the assembly 10. By combining signals from both the load sensor 20 and the accelerometer, the microcomputer 30 may be programmed to provide an a more accurate output signal to a user that is indicative of a total amount of liquid L (such as spirits or liquor) that might have been held within the cup 12 over a desired period of time, including measurement of the total amount of liquid L when the cup 12 has been repeatedly filled and emptied by a user over the course of an evening. Additionally, the motion sensor can allow for the assembly 10 to conserve battery power entering a “stand-by” mode, as further described below.

### EXAMPLES

In a preferred method embodiment, a user of the shot glass assembly 10 will turn on the power to the load sensor 20, microcomputer 30, display 50 and accelerometer, by pressing the on/off switch 70. The microcomputer 30 then will reset all appropriate internal counters to zero and output a signal that is indicative of being at an initial zero state; e.g. display the two digit “00” on the display 50. Then, as time goes by and as liquid L may be poured into the assembly 10 the load sensor 20 will provide a signal to the microcomputer 30 of such weight increase (which corresponds to the volume) of such liquid L increase within the cup 12. For example, in a preferred embodiment, the load sensor 20 can sense changes in weight to within 0.1 oz. By using known conversion factors, the microcomputer 30 converts this additional weight (e.g. oz) to a volume measurement appropriate for the liquid that is in the cup 12 (e.g. to represent fl. oz. of 80 proof alcoholic beverage) and then adds this to a volume counter variable programmed within the microcomputer 30; e.g. if 0.5 fl. oz. of liquid are added to the cup 12, the volume counter variable is increased by a corresponding 0.5 value.

Then, if the one or more addition(s) of liquid L to the cup 12 results in the volume counter variable meeting a desired threshold (e.g. 1 fl. oz), the microcomputer 30 updates the display 50 accordingly—e.g. when the volume counter reaches 1.0, the microcomputer 30 changes the initial “00” display to then read “01”—so as to indicate that at least 1 fl. oz of liquid L has been placed within the cup over the time period.

Once a user drinks from the cup 12 and empties some or all of the liquid L, the microcomputer will obtain a new reading of the weight of the cup 12 (and any remaining liquid L)—i.e. re-calibrate. Advantageously, motion input from the motion sensor may be used to trigger the microcomputer 30 to conduct such a re-calibration (e.g. when a user lifts the assembly 10 to take a drink from the cup 12). After such re-calibration if additional liquid L is added to the cup 12, the microcomputer will calculate this additional liquid amount (again, by obtaining sensory input from the load sensor 20), covert it to a volume measurement and add that amount to the volume counter variable (to represent a total amount of liquid L). Then, if this further addition(s) of liquid L to the cup 12 results in the volume counter variable meeting a desired threshold (e.g. another 1 fl. oz), the microcomputer 30 updates the display 50 accordingly—e.g. changing the “01” that was previously displayed to then read “02” so as to indicate that at least 2 fl. oz of liquid L have now been placed within the cup over the time period. As can now be appreciated, this process can be repeated over time, with the microcomputer 30 updating the volume counter variable upon each addition of liquid L to the cup 12 and providing a display representative of the total amount liquid L consumed over time.

Advantageously, a user of the shot glass assembly 10 can now rely on the microcomputer 30 to accurately track total consumption of an alcoholic beverage over the course of an evening, even if the cup 12 is only partially filled and without having to manually keep track of the number of times the cup 12 is filled. Preferably, the microcomputer 30 is programmed so that, if the new calculated amount of the volume counter variable is greater than 0.6, the display 50 will display the next higher number (ex. 2.6 ounces total results in a “03” being displayed; 5.3 ounces total results in a “05” being displayed). More advantageously, even if a user adds partial “shots” to the cup 12, e.g. two 0.4 fl. oz, the microcomputer 30 is preferably programmed (via the volume counter variable) to keep track of the total amount and update the display 50 according. The assembly 10 and microcomputer 30 may be turned-off to reset to a zero state via the on/off switch 70

For the embodiments of the shot glass assembly 10 having a motion sensor, such as an accelerometer, the microcomputer 30 may be programmed to go into a “stand-by” mode if motion is no longer sensed after a preset time (e.g. after 45 seconds). In such a “stand-by” mode, the display 50 and even the load sensor 20 may be turned off to conserve any batteries 40b. Upon further input from the motion sensor, the microcomputer 30 may then be programmed to come out of such “stand-by” mode, to provide power again to the load sensor 20 and to provide output again via the display 50.

Those of ordinary skill in the art will appreciate that various modifications to the invention as described herein will be possible without falling outside the scope of the invention. In the claims, the word “comprising” is used in its inclusive sense and does not exclude other elements being present. The indefinite article “a” before a claim feature does not exclude more than one of the features being present.

The embodiments of the invention in which an exclusive property or privilege is being claimed are defined as follows:

1. A shot glass assembly comprising:
a cup suitable to hold a quantity of liquid;
at least one load sensor;
a microcomputer; and
a power source;
wherein the load sensor is operative to sense the weight of the cup and any liquid therein.

2. The shot glass assembly of claim 1 further comprising a base.

3. The shot glass assembly of claim 2 further comprising a display.

4. The shot glass assembly of claim 3 wherein the microcomputer and power source are housed in the base;
and wherein the at least one load sensor is disposed between the cup and the base so as to at least partially support the cup, when the shot glass assembly is placed in a normal upright position on a generally horizontal surface.

5. The shot glass assembly of claim 4 further comprising cup retaining means to maintain the cup in an engagement position with the base during normal operations.

6. The shot glass assembly of claim 5 wherein the at least one load sensor comprises at least a first end and a second end;
and wherein the at least one load sensor is fastened to the base at the first end; and
wherein the cup retaining means comprises a clip member mounted to the second end of the at least one load sensor.

7. The shot glass assembly of claim 6 wherein the base further comprises at least one recess;
wherein the clip member further comprises at least one leg; and
wherein said at least one leg is adapted to engage said at least one leg so as to maintain the cup in the engagement position.

8. The shot glass assembly of claim 1 wherein the at least one load sensor provides a first signal that is indicative of the weight of the cup and any liquid therein; and
wherein the microcomputer processes said first signal to provide a first output that is indication of an amount of liquid held in the cup at a particular time.

9. The shot glass assembly of claim 7 wherein the at least one load sensor provides a first signal that is indicative of the weight of the cup and any liquid therein; and
wherein the microcomputer processes said first signal to provide an first output that is indication of an amount of liquid held in the cup at a particular time.

10. The shot glass assembly of claim 8, further comprising a multi-axis accelerometer.

11. The shot glass assembly of claim 9, further comprising a multi-axis accelerometer.

12. The shot glass assembly of claim 10, wherein the multi-axis accelerometer provides a second signal that is indicative of any motion or acceleration that may be experienced by the cup.

13. The shot glass assembly of claim 11, wherein the multi-axis accelerometer provides a second signal that is indicative of any motion or acceleration that may be experienced by the cup.

14. The shot glass assembly of claim 12, wherein the microcomputer processes said second signal to provide a second output that is indicative of a total volume of liquid held with the cup over a period of time.

15. The shot glass assembly of claim 13, wherein the microcomputer processes said second signal to provide a second output that is indicative of a total volume of liquid held with the cup over a period of time.
